(19) United States
(12) Patent Application Publication
(10) Pub. No.: US 2025/0049643 A1
(43) Pub. Date: Feb. 13, 2025

(54) PACIFIER RETENTION APPARATUS

(71) Applicant: Kelsey Joyce Martin, Reno, NV (US)

(72) Inventor: Kelsey Joyce Martin, Reno, NV (US)

(21) Appl. No.: 18/172,490

(22) Filed: Feb. 22, 2023

Related U.S. Application Data
(60) Provisional application No. 63/312,403, filed on Feb. 22, 2022.

(51) Int. Cl. A61J 17/00

(52) U.S. Cl. CPC A61J 17/1115

(57) ABSTRACT

In some embodiments, a pacifier retention apparatus includes a pacifier mount configured to couple a wristband to a pacifier, the pacifier mount including a pacifier mount base and a pacifier securing strap. The pacifier securing strap may be a silicone strap with an T shaped attachment member and a T shaped receiving cavity. In some embodiments, at least a portion of the pacifier retention apparatus includes a silicone material. The silicone material may have a Shore hardness that resists breakage when pulled during mounting, during use, or both, maintains shape to a degree sufficient to resist detachment during use, and provides a degree of stretch accommodating a range of pacifier sizes, pacifier shield aperture configurations, or both. The securing strap may be configured to pass through one or more pacifier shield apertures and to withdraw from the one or more pacifier shield apertures upon an occurrence of a detachment event.

### CROSS-REFERENCE TO RELATED APPLICATIONS

This application claims priority through the applicant's prior U.S. Provisional Patent Application No. 63/312,403 entitled “PACIFIER RETENTION APPARATUS” filed on Feb. 22, 2022, which application is hereby incorporated by reference in its entirety.

### COPYRIGHT

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### TECHNICAL FIELD

The present application relates to an apparatus for the retention of certain devices proximal to a person. In particular, this application relates to the retention of soothing devices, such as, for example, a pacifier, proximal to a child such that the child is able to obtain and utilize the soothing device at will.

### BACKGROUND ART

Parents who have used a pacifier as a method of soothing their baby have sometimes struggled with their babies repeatedly dropping the pacifier, resulting in the parent having to one or more of locate the pacifier, clean the pacifier, and reinsert the pacifier's mouth. This has been a frequent problem that occurred both during the day and during the night. During the day, whether the pacifier was, for example, dropped or thrown, the parent would typically have to locate the pacifier, clean it off, and reinsert it into the baby's mouth. As tedious as this process was, it was sometimes even worse when the pacifier could not be located at all. Often, the pacifier has rolled off and was deemed lost, or was lost during mobile activity, resulting in the one or more of the the parent panicking and trying to soothe the baby, the parent ordering costly replacement pacifiers. During the night, this often further interfered with the baby's sleep, the parents' sleep, or both. In some cases, babies were repeatedly losing their pacifier throughout the night. For some of these babies, in order for them to stay asleep or get back to sleep quickly upon awaking, they needed the pacifier. If they did not get it quickly, they would awake further and begin to cry, which sometimes then involved additional effort from the parent to get their baby back to sleep. To effectively get their baby to stay asleep and avoid this scenario, parents were often regularly running their hands through the crib trying to quickly, and without waking the baby, find the pacifier in the dark and insert it back into their baby's mouth. Even if the parent was successful in keeping the baby asleep in this instance, the issue of the parent's own sleep deprivation remained because they must stay awake performing this ongoing task.

One approach to trying to help the child retain the pacifier involved attaching it to the baby's clothing with a clip where a tether extended from the clip and to the pacifier. One problem with this approach can be that a baby's motor skills are not developed enough to locate the attached clip, follow the strap until it meets the pacifier, grab the pacifier, orient the pacifier, and then insert the pacifier into their mouth. Therefore, pacifier clothing clips often did not relieve the parent from constantly putting the pacifier back into the baby's mouth. Further, the night hours were the ones that are most inconvenient to be constantly placing the pacifier back into the baby's mouth. Even where the baby was coordinated enough to locate the pacifier using a pacifier clothing clip, the clip's long strap presents a risk of strangulation-a risk so great that the American Academy of Pediatrics advises that babies should not sleep or nap with a pacifier clip attached to their clothing. Because of these issues, the pacifier clothing clip does not provide a reliable solution to this problem.

One approach to trying to help the child retain the pacifier involved attaching the pacifier to stuffed animals. These solutions do not attach to the baby, so they could still fall on the floor, out of reach, and can become dirty. Further, because they are not attached to the baby, the baby is still unable to locate the pacifier themselves if it is out of reach. Therefore, this approach often does not solve the daytime problem. Further, for nighttime, the American Academy of Pediatrics states that babies should not sleep with these types of pacifiers unmonitored. Therefore, this approach does not solve the nighttime problem.

Some proposed solutions were designed such that they centered on the pacifier one or more of serving as a proxy for the infant's thumb, restricting access to the thumb, and limiting movement of the thumb. This created problems. First, by designing in such a way that the pacifier was positioned as a proxy for the thumb, when the pacifier was not available, the infant was more likely to suck their thumb, having been trained to do exactly that with the proxy. Second, restricting movement of the thumb, along with potential restricted access, limited the infant's ability to use their thumbs at a time when hand-eye coordination development and dexterity development are at an important stage. Finally, limiting the use of the thumb or hand introduced a new safety hazard in that the child could not use its hand to address certain dangers.

### SUMMARY OF THE INVENTION

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of this disclosure.

An adjustable pacifier retention wristband secured to the wrist can eliminate the use of tethers which can improve safety, reduce parental stress, or both, including reducing the risk of choking, the risk of strangulation, or both. Because it is attached to the baby's wrist, the adjustable pacifier retention wristband can allow the baby to easily locate the pacifier and soothe themselves at any time without parental involvement at an earlier stage of their development. Development and use of complex motor skills or investigation skills are not needed as the baby simply raises their wrist to their mouth and they are able to find comfort promptly. In some instances, this can happen in the first five months of development.

During the day, the adjustable pacifier retention wristband allows the baby to sooth themselves at any time and maintain a happy demeanor. It can eliminate the sporadic and severe cries that occur when the baby drops or cannot locate the pacifier, and it can further provide entertainment and stimulation for the baby. The adjustable pacifier retention wristband can improve child hand-eye coordination as well as discourage thumb sucking. During the night, the adjustable pacifier retention wristband can increase the amount of uninterrupted sleep for the baby, the parents, or both, providing one or more health benefits to both.

The adjustable pacifier retention wristband can address problems occurring both during the day and at night. During daytime hours, it can reduce or eliminate the need for the parent to search for the dropped pacifier, having to clean it before reinserting it into the baby's mouth, or both. It can also save the parent money by reducing or eliminating the need to purchase replacement pacifiers to replace the ones deemed lost after they have fallen or been thrown.

In some embodiments, at least a portion of the pacifier mount is made of silicone. Advantages and benefits obtained over elastic materials fabric, yarns, elastic cords and threads can include one or more of:
a. when dirty, silicone is easier to clean, whereas materials, fabrics, yarns, elastic cords and threads typically stain easily and resist cleaning;
b. the use of integral silicone removes the use of components susceptible to detachment, such as snap buttons, which can improve safety, such as by reducing the likelihood of choking were such potentially detachable components to detach;
c. silicone is flexible enough to pass through both the pacifier shield apertures, better securing the pacifier and keeping it more stationary without being rigid.
d. silicone retains its initial form and typically does not stretch out over time as compared to most traditional elastic materials, increasing the life of the product and maintaining a more consistent and secure pacifier position, making it easier for the infant or child to locate and manipulate the pacifier;
e. a silicone pacifier securing strap, such as a t-strap, can provide sufficient strength such that an infant cannot render the secure strap unattached, while remaining small and flexible enough that it can loosely fit through pacifier shield apertures diameters;
f. a silicone pacifier securing strap, such as a t-strap, can be sufficient in strength to support the addition of accessories, such as tethers, that can also attach;

The open design of the pacifier retention apparatus can provide improved range of motion of the thumb or hand as compared to other previous designs, and allows the hand to be used for things unrelated to the pacifier or pacifier retention, increasing safety, development capacity, and hand utility. Further, the positioning of the pacifier unrelated to the location of the thumb can reduce the reinforcement of thumb sucking behaviors via the pacifier as a proxy.

In some embodiments, the use of a thin securing strap, such as, for example, a silicone T strap, to secure the pacifier to the wrist strap can provide one or more of the further safety advantages. First, it can give the infant the ability to remove the pacifier from the mouth simply by moving their arm in the event the infant somehow begins to aspirate the pacifier. Further the degree of aspiration can also be limited by the T strap securing the pacifier closely to the wrist, abutting the wrist strap. Further still, in the event the pacifier is somehow pulled away from the wrist strap and subsequently aspirated, the action of removing the pacifier from the proximity of the wrist strap, fully withdraws the T strap from one or more of the apertures.

In some aspects, the techniques described herein relate to a pacifier retention apparatus including a pacifier mount configured to couple a wristband to a pacifier, the pacifier mount including a pacifier mount base and a pacifier securing strap.

In some aspects, the techniques described herein relate to a pacifier retention apparatus, wherein the pacifier securing strap further includes an attachment member.

In some aspects, the techniques described herein relate to a pacifier retention apparatus, wherein the attachment member is integral with a securing strap length portion.

In some aspects, the techniques described herein relate to a pacifier retention apparatus wherein the pacifier securing strap includes a securing strap length portion and an attachment member.

In some aspects, the techniques described herein relate to a pacifier retention apparatus wherein the attachment member includes a T shaped terminal end integral to a distal end of the securing strap length portion.

In some aspects, the techniques described herein relate to a pacifier retention apparatus wherein the securing strap length portion includes a silicone material.

In some aspects, the techniques described herein relate to a pacifier retention apparatus wherein the silicone material has a shore hardness operable to one or more of, resist breakage when pulled during mounting, during use, or both, maintain shape to a degree sufficient to resist detachment during use, and provide a degree of stretch accommodating a range of pacifier sizes, pacifier shield aperture configurations, or both.

In some aspects, the techniques described herein relate to a pacifier retention apparatus wherein the pacifier mount includes, a pacifier mount base including one or more attachment receiver cavities configured to receive an attachment member, and a securing strap, including a securing strap length portion, and at least one attachment member.

In some aspects, the techniques described herein relate to a pacifier retention apparatus further including, a wristband, wherein the wristband includes, a loop member configured to receive a pacifier mount base length portion, and a first end and a second end wherein the first end is configured to couple to the second end.

In some aspects, the techniques described herein relate to a pacifier retention apparatus wherein the wristband includes, a first portion and a second portion, wherein the first portion includes, a looping member configured to securely encircle a portion of a pacifier mount base length portion, and a first end configured to couple to a second end, and wherein the second portion includes, a looping member configured to securely encircle a portion of a pacifier mount base length portion, and a second end configured to couple to the first end.

In some aspects, the techniques described herein relate to a pacifier retention apparatus wherein the wristband includes a fabric portion and at least one attachment end.

In some aspects, the techniques described herein relate to a pacifier retention apparatus wherein the pacifier mount is coupled to the wristband.

In some aspects, the techniques described herein relate to a pacifier retention apparatus wherein the pacifier securing strap is configured to pass through one or more pacifier shield apertures.

In some aspects, the techniques described herein relate to a pacifier retention apparatus wherein the pacifier securing strap is configured to withdraw from the one or more pacifier shield apertures upon an occurrence of a detachment event.

In some aspects, the techniques described herein relate to a pacifier retention apparatus wherein the silicone material includes a shore hardness of approximately 50 Shore A.

In some aspects, the techniques described herein relate to a pacifier retention apparatus wherein the silicone material includes a shore hardness of approximately 50 Shore A.

In some aspects, the techniques described herein relate to a pacifier retention apparatus wherein the silicone material includes a shore hardness between 45 Shore A and 55 Shore A.

In some aspects, the techniques described herein relate to a pacifier retention apparatus wherein the silicone material includes a shore hardness between 30 Shore A to 44 Shore A.

In some aspects, the techniques described herein relate to a pacifier retention apparatus wherein the silicone material includes a shore hardness between 55 Shore A to 70 Shore A.

Unless otherwise noted, the terms “a” or “an,” as used in the specification are to be construed as meaning “at least one of.” In addition, for ease of use, the words “including” and “having,” as used in the specification, are interchangeable with and have the same meaning as the word “comprising.” In addition, the term “based on” as used in the specification is to be construed as meaning “based at least upon.”

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described to best explain the principles of the present systems and methods and their practical applications, to thereby enable others skilled in the art to best utilize the present systems and methods and various embodiments with various modifications as may be suited to the particular use contemplated.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a perspective view of a pacifier retention apparatus mounted to a wrist.

FIG. 2 is top view of the pacifier retention apparatus of FIG. 1.

FIG. 3 is a bottom view of the pacifier retention apparatus of FIG. 1.

FIG. 4 is a side elevation view of a wrist strap of the pacifier retention apparatus of FIG. 1.

FIG. 5 is a top view of a pacifier mounted to the pacifier retention apparatus of FIG. 1.

FIG. 6 is a top view of the pacifier retention apparatus of FIG. 1.

FIG. 7 is a perspective view of a pacifier mount of the pacifier retention apparatus of FIG. 1.

FIG. 8 is a side elevation view of the pacifier mount of FIG. 7.

FIG. 9 is a side cross section view of the t-strap attachment portion inserted into the t-strap receiver cavity of the pacifier mount base of the pacifier mount of FIG. 7.

FIG. 10 is a top view of the pacifier mount base of the pacifier mount of FIG. 7.

FIG. 11 is a top view of another embodiment of a pacifier retention apparatus.

FIG. 12 is a top view of a pacifier mounted to the pacifier retention apparatus of FIG. 11.

FIG. 13 is a perspective view of a pacifier mount of the pacifier retention apparatus of FIG. 11.

FIG. 14 is a side elevation view of the pacifier mount of FIG. 13.

FIG. 15 is a top view of the pacifier mount of FIG. 13.

FIG. 16 is a side view of the pacifier mount of FIG. 13.

FIG. 17 is a perspective view of a pacifier mount of another embodiment of the pacifier retention apparatus.

FIG. 18 is a top view of a pacifier mounted to a pacifier retention apparatus implementing the pacifier mount of FIG. 17.

FIG. 19 is a top view of a pacifier retention apparatus incorporating an elastic sheet.

### DETAILED DESCRIPTION

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of this disclosure.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” “approximately,” “nearly,” or the like, it will be understood that the particular value forms another aspect. It will be further understood that the endpoints of each of the ranges are significant both in relation to the other endpoint, and independently of the other endpoint.

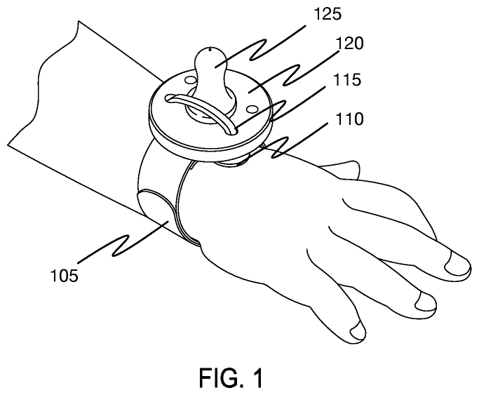

Referring now to FIG. 1, in some embodiments, the pacifier retention system includes a wristband 105 attached to a pacifier mount, the pacifier mount having a pacifier mount base 110 and a securing strap 115 passing across at least a portion of a pacifier shield top surface 120. In some instances, at least a portion of the wristband 105 of the pacifier retention apparatus is made of fabric, such as a soft fabric, and can be adjustable using, for example, Velcro, a buckle, snap fastener closure, or the like. The wristband 105 has an outer surface and an inner surface. The wristband 105 presents a length sufficient to wrap around a wrist with a portion of the wristband inner surface along the lateral edge overlapping a portion of the outer surface, the wristband being removably held in place by engagement of fasteners, such as, for example, snap fasteners, buckle fasteners, hook and loop fasteners, such as Velcro, and the like. In some instances, the wristband 105 is machine washable. In some instances, the wristband 105 is reversible. In some implementations, the securing strap 115 is made of a material with elastic properties, and centered, or approximately centered, on the wristband. In some instances, both ends of the securing strap 115 are attached permanently to the pacifier mount base 110, such as by stitching, gluing, molding, or the like. In other instances, the securing strap 115 is at least partially detachable from and re-attachable to the pacifier mount base 110 at an attachment end. In other embodiments, the securing strap is detachable from and re-attachable to the pacifier mount base 110 at both ends.

In some embodiments, the pacifier mount is a made of a silicone, such as, for example, food grade, BPA free, silicone, and produced from a silicon mold. In some instances, the silicone hardness is of a degree that facilitates, at least in part, one or more of resisting breakage when pulled during mounting, during use, or both, maintaining shape to a degree sufficient to resist detachment during use, and providing a degree of stretch accommodating a range of pacifier sizes, pacifier shield aperture configurations, or both.

In some instances, the silicone material has a shore hardness of approximately 50 Shore A. In other instances, the silicone material has a shore hardness between 45 Shore A and 55 Shore A. In other embodiments, the silicone material has a shore hardness between 30 Shore A to 44 Shore A. In other embodiments, the silicone material has a shore hardness between 55 Shore A to 70 Shore A.

In other embodiments, a pacifier 125 can be secured to the wristband 105 by for example, an attachment loop with a slip knot coupled to a pacifier handle member, nipple member, or aperture. After attaching the pacifier to the wristband, the wristband can be attached to the infant or child's wrist in a direction that would position the pacifier desirably to meet the infant's or child's mouth when raised to the mouth. The attachment loop can be sewn to the wristband such that the attachment loop, and then pacifier, are encouraged to fall in predetermined direction. Snap fasteners can be used to secure the wrist band portion around the baby's wrist.

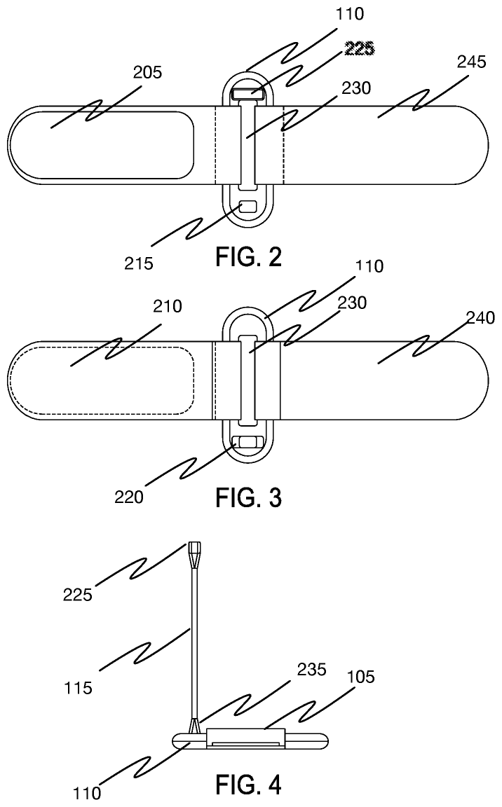

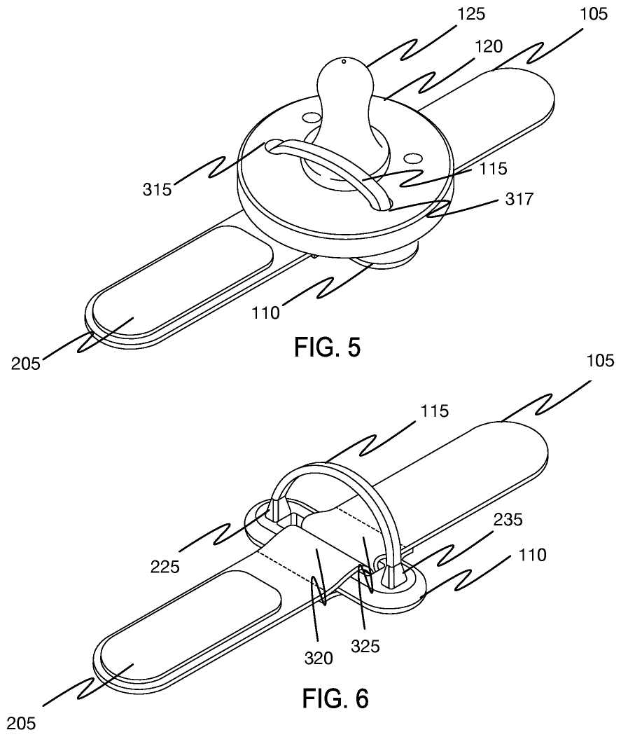

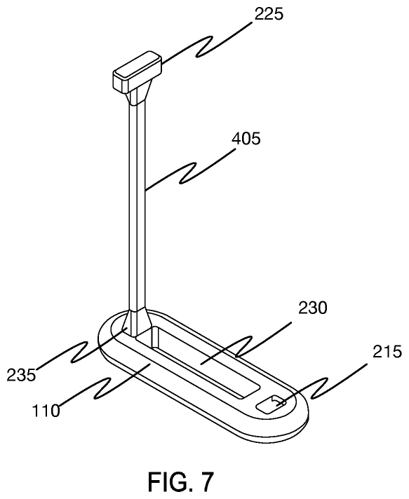

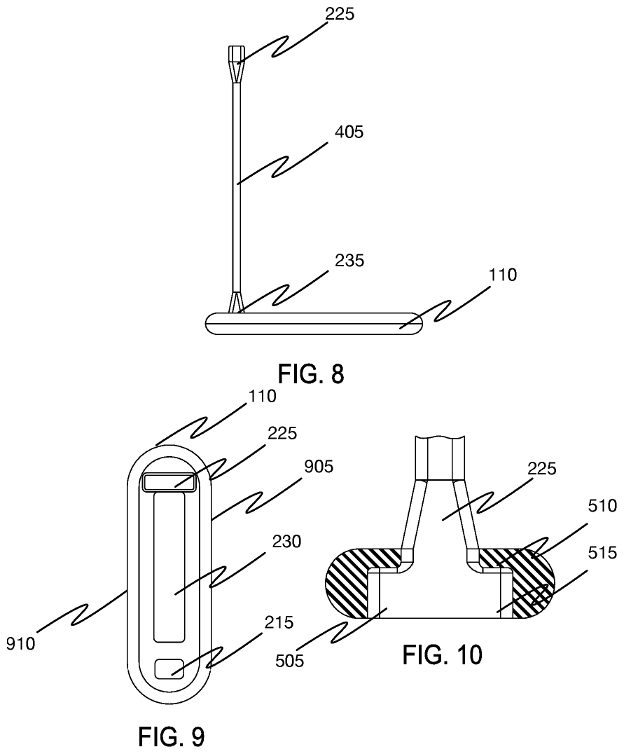

Referring now to FIG. 2 through FIG. 10, in some embodiments, the wristband includes a hook portion Velcro patch 210 sewn into, or otherwise attached to, the inner surface 240 at or near at least one end of the wristband 105. The wristband can be made of fabric that will adhere to the hook portion Velcro patch 210. In some instances, one end of the wristband 105 includes the hook portion Velcro patch 210, and the other end of the wristband 105 includes the loop member of Velcro patch 205, with one being attached to the wristband inner surface 240 and the other being attached to the wristband outer surface 245. If designed to be reversible, both sides can be made with Velcro adherable fabric, include both Velcro pairing constructs, or both. If not reversible, in some implementations, the side abutting the infant's or child's skin is made with adherable fabric. In some embodiments, a Velcro component allows for size adjustment. In some implementations, the wristband includes at least two attachable portions, each such portion including am attachable end on one end and a loop member 320, 325 on the other end, each loop member configured to wrap around a pacifier mount base length portion 905, 910, either detachably or permanently.

In some embodiments, the pacifier mount includes a pacifier mount base 110, two or more pacifier mount base length portions 905, 910, a pacifier mount base aperture 230 adjacent to and extending the length of each pacifier mount base length portion 905, 910 configured to receive a wristband loop member, a securing strap 115 integral to the pacifier mount base at one end positioned on top surface along the width portion of the pacifier mount base 235, an attachment member 225, and a receiving member configured to engage with the attachment member 225. In some embodiments, the attachment member is a T shaped terminal end of the securing strap 115, and the receiving member includes a T shaped cavity 220 and aperture 215, the aperture 215 configured to allow the T shaped terminal end to pass through the aperture and fill or approximately fill the T shaped cavity 220 where the two protruding portions of the T shaped terminal end 505, 515 are frictionally retained by the inner surface of the T shaped cavity 510.

In some embodiments, the securing strap 115 is of a length and flexibility sufficient to pass through one or more pacifier shield apertures 315, 317. In some instances, the thickness, shape, or both of the securing strap length portion 405 are such that the one or more pacifier shield apertures 315, 317 are relatively unobstructed with respect to the flow of water or air through the aperture, and such that the securing strap length portion 405 and attachment member 225 can easily pass through the one or more pacifier shield apertures 315, 317 when the pacifier is moved distally from the wristband 105, such as the complete withdraw of the securing strap from the pacifier mount shield apertures upon the occurrence of a detachment event.

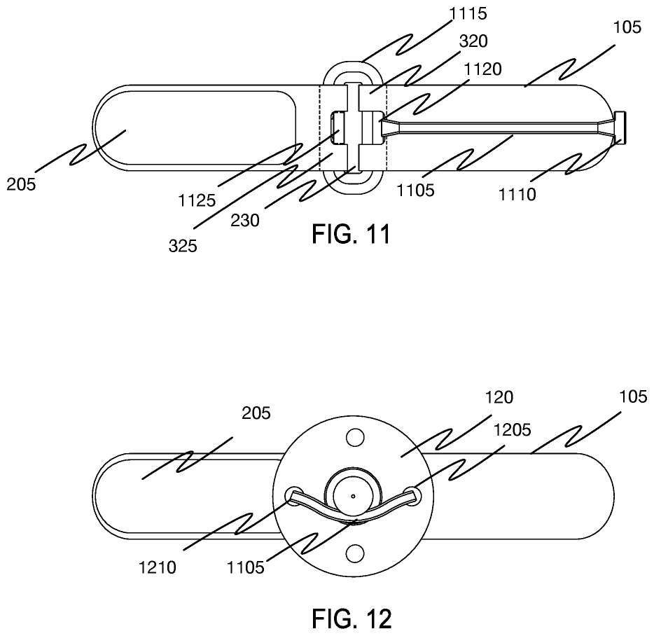

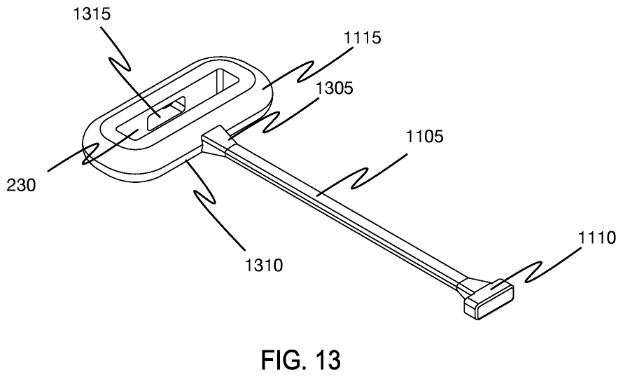

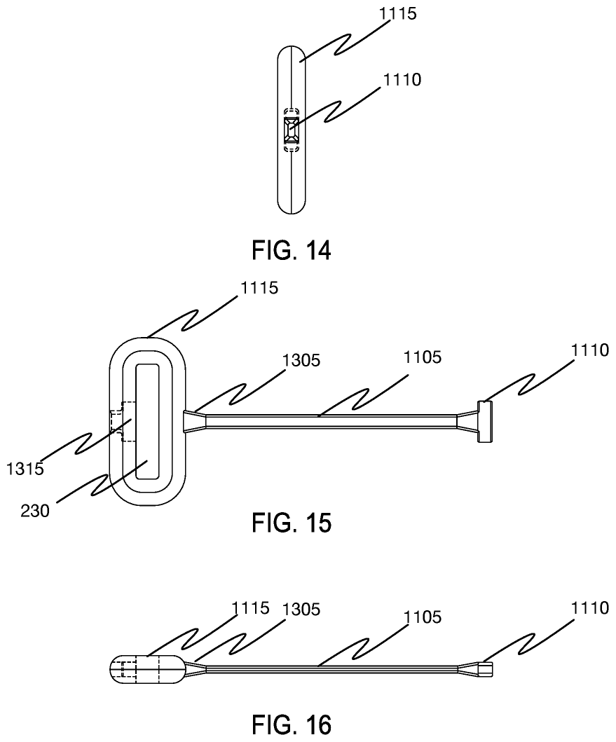

Referring now to FIG. 11 through FIG. 16, in other embodiments, the securing strap 1105 is integral to the pacifier mount base 1115 at an attachment point 1305 positioned on the side surface along a pacifier mount base length portion 1310 such that the securing strap 1105 will extend in a line along the length of the wristband 105 when securing the pacifier. In some instances, the securing strap passes through one or more pacifier shield apertures 1205, 1210, securing the pacifier in a lengthwise fashion. In some embodiments, the loop members 320, 325 each include a cutout portion 1120, 1125 configured to allow the securing strap 1105 and the attachment member 1110 to pass through such that the attachment member 1110 can be received at the receiving member 1315.

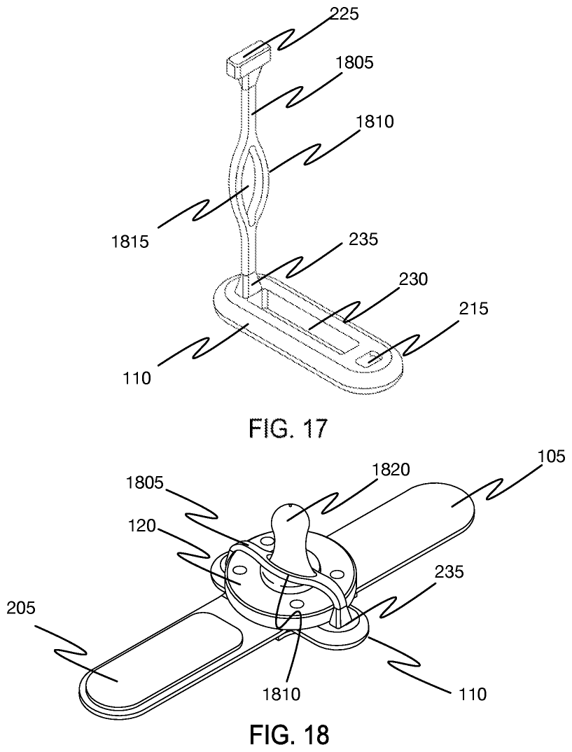

Referring now to FIG. 17 and FIG. 18, the securing strap 1805, rather than passing through one or more pacifier shield apertures 315, 317, includes an aperture 1815 configured to receive the nipple member 1820 of the pacifier such that the securing strap 1805 can secure the pacifier in a line along the approximate center of the pacifier shield, with a portion of the securing strap 1810 positioned along opposing sides of the nipple member 1820 of the pacifier.

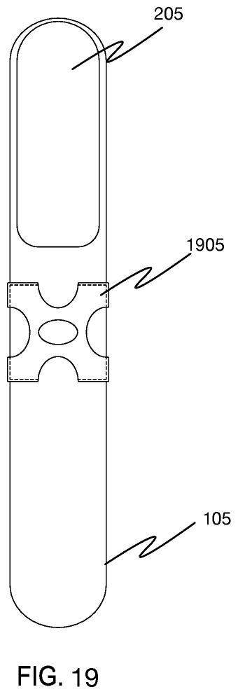

Referring now to FIG. 19, in other embodiments, a layer of elastic material, such as neoprene, is permanently attached to the wristband, in some cases, near the approximate center of the wristband, such as by stitching along at least a portion of the edges of the neoprene. The neoprene layer includes an aperture of sufficient diameter and flexibility to receive the nipple member of the pacifier. The neoprene layer is further sufficiently elastic to allow the pacifier shield and nipple member to pass between the outer surface of the wrist band and the elastic layer inner surface, the nipple member then passing through the elastic layer aperture such that the elastic layer abuts at least a portion of the pacifier shield, securing it in a position abutting the outer surface of the wristband.

In some embodiments, an attachment loop can be elastic material and approximately centered on the band. Both ends of the loop can be sewn to the wristband. A pacifier can be secured to the wristband by for example, an attachment loop with a slip knot coupled to a pacifier handle or pacifier shield aperture. After attaching the pacifier to the wristband, the wristband can be attached wrist in the direction that would best position the pacifier to meet the infant's or child's mouth when raised to mouth. The attachment loop can be sewn to the wristband portion such that the attachment loop, and then pacifier, are encouraged to fall in predetermined direction.

In some instances, the pacifier retention apparatus includes two attachment loops made of an elastic material and approximately centered on the wristband. In some instances, each loop end is sewn to the wristband portion. The pacifier shield can have multiple apertures that can be used to secure the pacifier to the wrist band portion using the attachment loops (3d) with a slip knot.

In some embodiments, the pacifier is permanently sewn into the wristband, or the pacifier is integral to the wristband with only the nipple member portion of the pacifier protruding out from the outer surface of the wristband portion.

In some instances, the wristband can be integral to a sleep sack or long sleeve upper body clothing portion shirt. In some instances, a pacifier sewn into the wrist area of the clothing. In other instances, the sleep sack or long sleeve upper body clothing portion has a pacifier mount configured to receive a retaining portion of a pacifier, such as by using a securing strap.

In some embodiments, the pacifier retention apparatus includes multiple securing straps approximately centered on the wristband, permanently attached on one end, and removably attached on the other end, configured to pass through one or more pacifier shield apertures.

In some embodiments, a clip is permanently attached to a small piece of fabric which is permanently attached to an attachment loop on the opposite end. The attachment loop can be made of an elastic material and can attach to a pacifier with a slip knot. The clip can secure to the end of a sleeve of an upper body clothing portion or sleep sack so that it lies at the infant's or child's wrist area.

In some instances, the a pacifier attachment loop can be permanently sewn into the wrist area of a sleep sack or a long sleeve upper body clothing portion.

In some embodiments, a pacifier attachment loop is approximately centered, hanging vertically from a top edge of the wristband to near the bottom edge of the wristband. The pacifier attachment loop can be sewn to the wristband portion. The attachment loop can be be sewn in a way that the loop, and then the pacifier, are encouraged to fall in a pre-determined direction.

In some embodiments, approximately centered on the band can be another strap permanently sewn to the wristband portion on both sides with a silicone circle looped into the middle. This circle can, for example, serve as a teether. There can be an opening in the teether where an attachment loop extends, such as an elastic or silicone loop. This loop can be either attached to the band, teether, or molded as integral to the teether circle. The attachment loop can be approximately centered in the pacifier shield aperture. After the pacifier is attached to the attachment loop, such as with a slip knot, the pacifier can be approximately centered in the teether. The teether can be designed in a way to help secure the pacifier in place.

In some embodiments, rather than being secured by straps, the silicone circle is attached to each end of the wristband. In some instance, the silicone circle acts as a teether.

In some instances, there are two securing straps permanently sewn to the wristband portion on one end that can pass through one or more pacifier shield apertures. The ends of these straps can have a diagonal strap that hooks into one or more pacifier shield apertures permanently sewn into the wristband, securing the pacifier.

In some embodiments, a circular teether is sewn into the center of wristband using fabric looped through slits. On the edges of the circle opposite to the slits are one or more additional slits. In some instances, at the innermost point of one or more of these slits, there is a circular opening. Connected along the inner circular opening of the teether, there can be one or more stretchable connector straps on each side. These straps can loop through a pacifier shield aperture, weave into a slit, and nest into a cutout on the bottom of the teether.

In some embodiments, a circular teether can be permanently secured to the wristband with fabric looped through slits. On each side of the teether are apertures through which an securing strap can pass. These securing straps can have a wider circle at the end that loop through the circle on the pacifier and secure the pacifier to the teether. There can be a cavity inside the teether where the apertures are located so that the securing straps can be pushed in when not in use with a pacifier. This can allow for a flush teether. The securing straps can be molded into the teether, and this can be designed so that they are attached to the wristband permanently and weaved through the teether. The slits can also be implemented so that the securing straps can be hooked into them when not in use with the pacifier.

Although the described embodiments of the present invention are believed to represent the best mode of the present invention, it should be understood that many described components of the present invention have known functional equivalents. Additionally, orientations, proportions and shapes used within the description may be modified by a person skilled in the art. All such modifications and deviations are intended to be covered by the scope of the invention.

Clause 1. A pacifier retention apparatus comprising a pacifier mount configured to couple a wristband to a pacifier, the pacifier mount comprising a pacifier mount base and a pacifier securing strap.

Clause 2. The pacifier retention apparatus of clause 1, wherein the pacifier securing strap further comprises an attachment member.

Clause 3. The pacifier retention apparatus of clause 2, wherein the attachment member is integral with a securing strap length portion.

Clause 4. The pacifier retention apparatus of claim 1 wherein the pacifier securing strap comprises a securing strap length portion and an attachment member.

Clause 5. The pacifier retention apparatus of claim 4 wherein the attachment member comprises a T shaped terminal end integral to a distal end of the securing strap length portion.

Clause 6. The pacifier retention apparatus of claim 4 wherein the securing strap length portion comprises a silicone material.

Clause 7. The pacifier retention apparatus of claim 6 wherein the silicone material has a shore hardness operable to one or more of, resist breakage when pulled during mounting, during use, or both, maintain shape to a degree sufficient to resist detachment during use, and provide a degree of stretch accommodating a range of pacifier sizes, pacifier shield aperture configurations, or both.

Clause 8. The pacifier retention apparatus of claim 1 wherein the pacifier mount comprises, a pacifier mount base comprising one or more attachment receiver cavities configured to receive an attachment member, and a securing strap, comprising a securing strap length portion, and at least one attachment member.

Clause 9. The pacifier retention apparatus of claim 1 further comprising, a wristband, wherein the wristband comprises, a loop member configured to receive a pacifier mount base length portion, and a first end and a second end wherein the first end is configured to couple to the second end.

Clause 10. The pacifier retention apparatus of claim 9 wherein the wristband comprises, a first portion and a second portion, wherein the first portion comprises, a looping member configured to securely encircle a portion of a pacifier mount base length portion, and a first end configured to couple to a second end, and wherein the second portion comprises, a looping member configured to securely encircle a portion of a pacifier mount base length portion, and a second end configured to couple to the first end.

Clause 11. The pacifier retention apparatus of claim 9 wherein the wristband comprises a fabric portion and at least one attachment end.

Clause 12. The pacifier retention apparatus of claim 9 wherein the pacifier mount is coupled to the wristband.

Clause 13. The pacifier retention apparatus of claim 1 wherein the pacifier securing strap is configured to pass through one or more pacifier shield apertures.

Clause 14. The pacifier retention apparatus of claim 13 wherein the pacifier securing strap is configured to withdraw from the one or more pacifier shield apertures upon an occurrence of a detachment event.

Clause 15. The pacifier retention apparatus of claim 6 wherein the silicone material comprises a shore hardness of approximately 50 Shore A.

Clause 16. The pacifier retention apparatus of claim 6 wherein the silicone material comprises a shore hardness of approximately 50 Shore A.

Clause 17. The pacifier retention apparatus of claim 6 wherein the silicone material comprises a shore hardness between 45 Shore A and 55 Shore A.

Clause 18. The pacifier retention apparatus of claim 6 wherein the silicone material comprises a shore hardness between 30 Shore A to 44 Shore A.

Clause 19. The pacifier retention apparatus of claim 6 wherein the silicone material comprises a shore hardness between 55 Shore A to 70 Shore A.

1. A pacifier retention apparatus comprising a pacifier mount configured to couple a wristband to a pacifier, the pacifier mount comprising a pacifier mount base and a pacifier securing strap.

2. The pacifier retention apparatus of claim 1, wherein the pacifier securing strap further comprises an attachment member.

3. The pacifier retention apparatus of claim 2, wherein the attachment member is integral with a securing strap length portion.

4. The pacifier retention apparatus of claim 1 wherein the pacifier securing strap comprises a securing strap length portion and an attachment member.

5. The pacifier retention apparatus of claim 4 wherein the attachment member comprises a T shaped terminal end integral to a distal end of the securing strap length portion.

6. The pacifier retention apparatus of claim 4 wherein the securing strap length portion comprises a silicone material.

7. The pacifier retention apparatus of claim 6 wherein the silicone material has a shore hardness operable to one or more of,
resist breakage when pulled during mounting, during use, or both,
maintain shape to a degree sufficient to resist detachment during use, and
provide a degree of stretch accommodating a range of pacifier sizes, pacifier shield aperture configurations, or both.

8. The pacifier retention apparatus of claim 1 wherein the pacifier mount comprises,
a pacifier mount base comprising one or more attachment receiver cavities configured to receive an attachment member, and
a securing strap, comprising a securing strap length portion, and at least one attachment member.

9. The pacifier retention apparatus of claim 1 further comprising, a wristband, wherein the wristband comprises,
a loop member configured to receive a pacifier mount base length portion, and
a first end and a second end wherein the first end is configured to couple to the second end.

10. The pacifier retention apparatus of claim 9 wherein the wristband comprises,
a first portion and a second portion,
wherein the first portion comprises,
a looping member configured to securely encircle a portion of a pacifier mount base length portion, and
a first end configured to couple to a second end, and
wherein the second portion comprises,
a looping member configured to securely encircle a portion of a pacifier mount base length portion, and
a second end configured to couple to the first end.

11. The pacifier retention apparatus of claim 9 wherein the wristband comprises a fabric portion and at least one attachment end.

12. The pacifier retention apparatus of claim 9 wherein the pacifier mount is coupled to the wristband.

13. The pacifier retention apparatus of claim 1 wherein the pacifier securing strap is configured to pass through one or more pacifier shield apertures.

14. The pacifier retention apparatus of claim 13 wherein the pacifier securing strap is configured to withdraw from the one or more pacifier shield apertures upon an occurrence of a detachment event.

15. The pacifier retention apparatus of claim 6 wherein the silicone material comprises a shore hardness of approximately 50 Shore A.

16. The pacifier retention apparatus of claim 6 wherein the silicone material comprises a shore hardness of approximately 50 Shore A.

17. The pacifier retention apparatus of claim 6 wherein the silicone material comprises a shore hardness between 45 Shore A and 55 Shore A.

18. The pacifier retention apparatus of claim 6 wherein the silicone material comprises a shore hardness between 30 Shore A to 44 Shore A.

19. The pacifier retention apparatus of claim 6 wherein the silicone material comprises a shore hardness between 55 Shore A to 70 Shore A.
